(19) United States
(12) Patent Application Publication
(10) Pub. No.: US 2026/0131367 A1
(43) Pub. Date: May 14, 2026

(54) LOW-LOSS THIN AMORPHOUS ALLOY STRIP AND THE MANUFACTURING DEVICE AND METHOD THEREOF

(71) Applicant: Qingdao Yunlu Advanced Materials Technology Co., Ltd., Qingdao (CN)

(72) Inventors: Yuanhua Zeng, Qingdao (CN); Xiaoyu Li, Qingdao (CN); Jing Pang, Qingdao (CN); Zefan Wang, Qingdao (CN); Zhiqiang Wang, Qingdao (CN)

(21) Appl. No.: 19/031,820

(22) Filed: Jan. 18, 2025

Related U.S. Application Data
(63) Continuation of application No. PCT/CN2024/131900, filed on Nov. 14, 2024.

(51) Int. Cl. B21B 1/24

(52) U.S. Cl. CPC B21B 1/24; B21B 3/00; B21B 3/02; B21B 15/0007; B32B 3/263; B32B 3/266; B32B 3/30; Y10T 428/12389; Y10T 428/12396; Y10T 428/12431; Y10T 428/12465; Y10T 428/12993

(57) ABSTRACT

A method of manufacturing a thin amorphous alloy strip with notches, the method comprising forming notches on a smooth amorphous alloy strip using a cutting roller in a notching operation, wherein the cutting roller has a cylindrical body, the body is provided on the surface with at least one spirally extending cutting edge; and during the notching operation, the cutting roller is pressed against the amorphous alloy strip and rotated, wherein an incident angle of the cutting edge is in the range of 20°-30°; a notching pressure is in the range of 5-8 g; and an extension direction of any point on the cutting edge has an angle in the range of 20-60° with a travel direction of the amorphous alloy strip.

### INTRODUCTION

The present invention relates to a thin amorphous alloy strip and the manufacturing method thereof, and in particular relates to a thin amorphous alloy strip with appropriate magnetic domain refining grooves on the surface.

### BACKGROUND

Amorphous alloy materials have excellent properties such as low coercivity, high magnetic permeability, low saturation magnetic induction and high resistivity, and are widely used in electronic, electric and new energy industries. Thin amorphous alloy strips are often used in distribution transformers to reduce the no-load loss of the distribution transformers by taking advantage of the low magnetic loss of the amorphous alloy. In order to further reduce the anomalous eddy current loss, which is an important component of iron loss, linear or dotted notches can be provided on the surface of the thin amorphous alloy strip to refine the magnetic domain and reduce the width of magnetic domains. Due to the thinness, high hardness, low toughness and susceptibility to stress of amorphous alloy strips, it is difficult to use mechanical methods to form satisfactory notches on amorphous alloy strips in mass production. At present, major manufacturers mainly use laser notching method as the preferred method to reduce iron loss and improve the thin amorphous alloy strip.

JPH3-32886 discloses a method of improving the magnetic properties of an amorphous strip by laser notching. By irradiating a pulsed laser in the width direction of the thin amorphous alloy strip, the surface of the thin amorphous alloy strip is locally melted instantaneously. Then the thin amorphous alloy strip is quenched and the melted surface is solidified to form amorphous spots arranged in arrays to refine the magnetic domains.

During the process of laser notching, the high temperature and overheating generated by laser irradiation will lead to phase explosion mainly in the form of boiling and spattering, resulting in the formation of re-melted matter, spattered matter, etc. in the notching area, which will destroy the thickness uniformity and flatness of the notching area, and the melted and recrystallized part will also have an adverse effect on the performance of the strip. In particular, the melt produced by ablative spurt will become inevitable and will uncontrollably accumulate on both sides of the notched groove, affecting the lamination factor of the subsequent product. In addition, the laser notching method also causes high energy consumption, and therefore high production costs.

### SUMMARY

In view of the above-mentioned deficiencies in the prior art, the object of the present invention is to provide a mechanical manufacturing method of low-loss thin amorphous alloy strip, which can manufacture a low-loss thin amorphous alloy strip with the advantages of small excitation power, high flatness, and low energy consumption.

In one embodiment, the present invention provides a method of manufacturing a thin amorphous alloy strip with notches. The method comprises forming notches on a smooth amorphous alloy strip using a cutting roller in a notching operation, wherein the cutting roller has a cylindrical body; the body is provided on the surface with at least one spirally extending cutting edge; and during the notching operation, the cutting roller is pressed against the amorphous alloy strip and rotated, wherein an incident angle of the cutting edge is in the range of 20°-30°; a notching pressure is in the range of 5-8 g; and the angle between the extension direction of any point on the cutting edge and the travel direction of the amorphous alloy strip is in the range of 20-60°.

In another embodiment, the present invention provides another method of manufacturing a thin amorphous alloy strip with notches. The method comprises forming notches on a smooth amorphous alloy strip using a cutting roller in a notching operation, wherein the cutting roller has a cylindrical body; the body is provided on the surface with at least one transversely extending cutting edge; and during the notching operation, the cutting roller is pressed against the amorphous alloy strip and rotated around a central axis while moving in a travel direction perpendicular to the travel direction of the strip, wherein during the notching operation, the pressure at the cutting edge is in the range of 0.1-1 MPa/cm².

In one embodiment, the present invention provides a manufacturing device for forming notches on an amorphous alloy strip, the device comprising:
a discharging unit, which discharges a strip roll;
a length metering mechanism, which meters the length that the strip has travelled;
a tension detecting mechanism, which detects the tension of the strip;
a tension adjusting mechanism, which adjusts the tension of the strip;
a process deviation rectifying mechanism, which ensures that the strip does not deviate in operation;
a notching mechanism, which carries out a notching operation on the strip; and
a receiving mechanism which winds up the amorphous alloy strip that has been notched, wherein the notching mechanism comprises a cutting roller traveling mechanism, a cutting roller and a cutting board, and the cutting roller has a cylindrical body and at least one cutting edge protruding from the surface of the body and extending circumferentially or spirally on the surface of the body.

The thin amorphous alloy strip with notches produced according to the present invention has the advantage of having only tiny bulges on both sides of the notched groove, which increases the lamination factor and further reduces the loss and excitation power of the iron core made of such strip.

### BRIEF DESCRIPTION OF THE DRAWINGS

FIG. 1 schematically shows an overall mechanical notching device according to the present invention.

FIGS. 2a and 2b schematically show a side view of the notching mechanism in the overall mechanical notching device according to the present invention.

FIG. 3 schematically shows a transverse cutting roller according to the present invention.

FIGS. 4a and 4b schematically show a spiral cutting roller according to the present invention.

FIGS. 5a-5e schematically show various notch arrangement patterns on the strip, wherein FIG. 5a shows continuous linear notch arrays, FIG. 5b shows discontinuous linear notch arrays, FIGS. 5c and 5d shows discontinuous linear notch arrays arranged in a staggered manner, and FIG. 5e shows discontinuous linear notch arrays with inclination angles.

FIG. 6 schematically shows a notched area on the strip surface.

### DETAILED DESCRIPTION

The specific contents of the present invention will be described in detail below in conjunction with the accompanying drawings and embodiments. It should be understood, however, that the described embodiments are only for illustration purpose. A person of ordinary skill in the art is capable of making changes based on the embodiments of the present invention without departing from the scope claimed by the present invention.

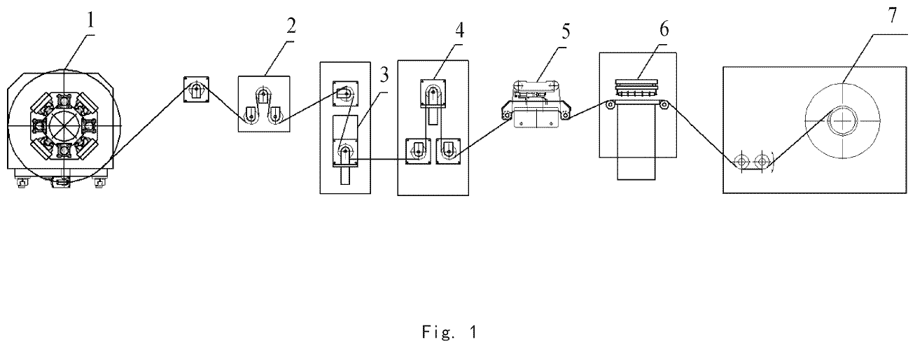

The present invention provides a method of forming notches on the surface of a thin amorphous alloy strip using a mechanical notching method to refine the magnetic domains. FIG. 1 schematically shows an overall device according to the mechanical notching method of the present invention.

The overall device shown in FIG. 1 is controlled by an electric control system, and comprises a discharging unit 1, a length metering mechanism 2, a tension detecting mechanism 3, a tension adjusting mechanism 4, a process deviation rectifying mechanism 5, a notching mechanism 6 and a receiving mechanism 7.

During the operation of the device, the strip roll is unwound by the discharging mechanism 1. The strip unwound by the discharging mechanism 1 enters the length metering mechanism 2 via a process roller. The length metering mechanism 2 is mainly used for metering the length that the strip has travelled. Especially, when a transverse roller is used, after each notching, the strip is controlled to travel for a certain length and then stopped for carrying out the next notching.

The main structure of the length metering mechanism 2 comprises three rollers. The two lower rollers are steel rollers, including a first diverting roller A and a second diverting roller B. The upper roller is a length metering roller with a rubber surface. A central shaft of the length metering roller is connected with an encoder to meter the length that the strip has travelled.

The strip enters the first diverting roller A from below the first diverting roller A, then extends upwards and goes around the length metering roller, then extends downwards and goes around the second diverting roller B from below the second diverting roller B on the left side, and finally leaves the length metering mechanism 2 from the right side of the second diverting roller B.

In order to ensure the accuracy of strip metering, it is necessary to ensure that the length metering roller and the strip travel synchronously without slipping. For this purpose, in addition to designing the length metering roller to be made of a rubber material to increase friction, the area of contact of the strip with the length metering roller can also be increased. According to a preferred embodiment, the spacing between the first diverting roller A and the second diverting roller B is designed to be smaller than the diameter of the length metering roller, whereby the strip that goes around the length metering roller covers a majority of the circumference of the length metering roller, thereby further increasing the friction and improving the accuracy of the measurement of the length that the strip has travelled.

The strip that comes out from the length metering mechanism 2 passes through the tension detecting mechanism 3 and the tension adjusting mechanism 4 in sequence. According to the feedback of the tension detecting mechanism 3 about the tension of the strip, the tension adjusting mechanism 4 adjusts the tension of the strip. Tension detection and tension adjustment can bring the advantages of avoiding excessive strip tension which may cause breakage, ensuring that the strip is tightened on the cutting board of the notching mechanism to facilitate the notching operation when the strip enters the notching station subsequently, and preventing the strip tension from being too small so that the friction between the strip and rollers is insufficient, which may lead to inaccurate length measurement of the length metering mechanism 2.

The process deviation rectifying mechanism 5 ensures that the strip is at a suitable processing station when entering the notching mechanism 6 without deviation, thereby ensuring the quality of notches.

After the strip is notched in the notching mechanism 6, it enters the receiving mechanism 7 directly. The receiving mechanism 7 comprises a guide roller system and a receiving tray. The guide roller system includes a floating roller for ensuring the tension of the strip in the receiving mechanism and the tension of the notched strip in the notching mechanism.

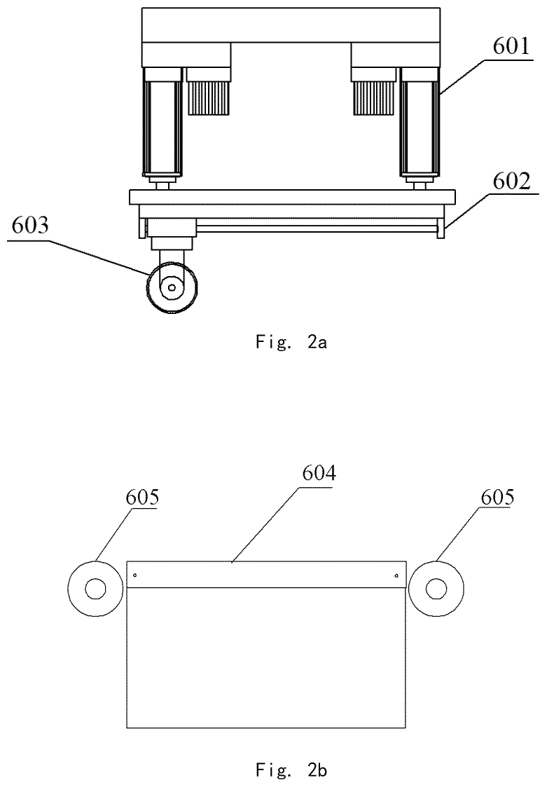

FIG. 2a and FIG. 2b specifically illustrate the notching mechanism 6 according to the present invention. The notching mechanism 6 comprises a cutting roller traveling mechanism, a cutting roller and a cutting board. As shown in FIG. 2a, the cutting roller traveling mechanism comprises at least two electric cylinders 601 for controlling the cutting roller to move up and down, which are preferably arranged on the periphery so as to ensure that the cutting roller below is evenly stressed during notching and does not deviate. A linear motor 602 is fixed below the electric cylinders 601. A cutting roller 603 in the form of a pressure roller is fixedly mounted on the traveling element of the linear motor 602. During the notching operation, the thin amorphous alloy strip is spreaded on the cutting board 604, and the traveling element of the linear motor 602 drives the cutting roller 603 to move along a straight line in a travelling direction from its initial position, and continuously roll at least one side of the thin amorphous alloy strip to form mechanical notches on the surface of the strip. Subsequently, the notched part of the amorphous strip leaves the notching mechanism, and the cutting roller 603 returns back to its initial position along with the traveling element of the motor so that the next notching operation can be carried out. As shown in FIG. 2b, process rollers 605 are arranged on both sides of the cutting board 604 respectively. The upper end faces of the outer diameters of the process rollers 605 locate in the same plane with the upper surface of the cutting board, whereby it can be ensured that the strip is tightened and the notching is accurate in the notching process, and the strip does not rub the outer edge of the cutting board on both sides, reducing the risk of scratching the strip.

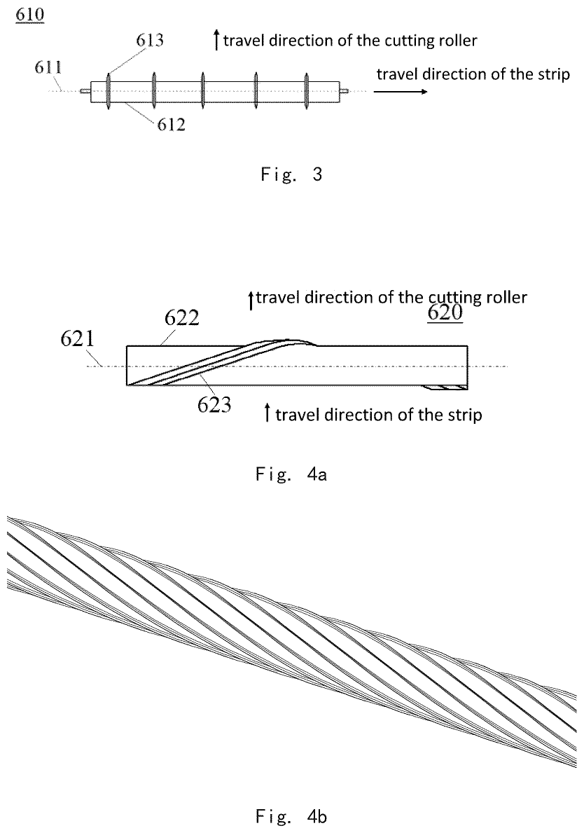

In one embodiment, the cutting roller 603 according to the present invention takes the form of a transverse cutting roller 610 as shown in FIG. 3. The transverse cutting roller 610 has a cylindrical body 612, which has a central axis 611. The surface of the body 612 is circumferentially provided with at least one cutting edge 613 in the form of a protruding ridge. In the embodiment as shown in FIG. 3, the cutting edge 613 extends laterally on the body 612, that is, the central plane passing through the end of the cutting edge 613 is perpendicular to the axis 611. When installed in the notching mechanism 6, the axis 611 of the transverse cutting roller 610 can be at an angle of less than 45° with the travel direction of the strip as required. Thus, when the traveling element of the linear motor starts, it will drive the transverse cutting roller 610 to move linearly in a travel direction perpendicular to the strip casting direction. Meanwhile, the transverse cutting roller 610 is driven to rotate around the central axis 611 under the interaction with the strip, and in turn rolls the stationary strip below on the cutting board, so that the cutting edge 613 squeezes the strip material and thereby produces a notch on the surface of the strip.

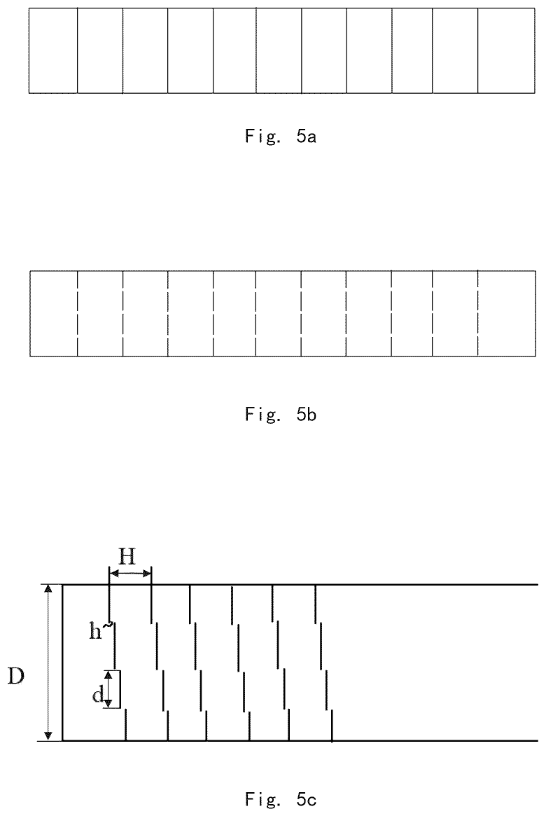

In another embodiment, the cutting roller 603 according to the present invention takes the form of a spiral cutting roller 620 as shown in FIGS. 4a and 4b. The spiral cutting roller 620 has a cylindrical body 622 having a central axis 621. The surface of the body 622 is provided with at least one cutting edge 623 in the form of a protruding ridge. In the embodiments shown in FIGS. 4a and 4b, the cutting edge 623 extends spirally on the surface of the body 622. The spiral cutting roller 620 is installed in the notching mechanism 6 in such a way that its axis 621 is perpendicular to the travel direction of the strip. Thus, when the traveling element of the linear motor starts, it will drive the spiral cutting roller 620 to move in a travel direction parallel to the strip casting direction. Meanwhile, the spiral cutting roller 620 is driven to rotate around the central axis 611, and in turn rolls the strip below, so that the cutting edge 623 squeezes the strip material and thereby produces a notch on the surface of the strip.

The spiral cutting roller may also be a driven roller. In such an embodiment, the notching mechanism may not have a linear motor. During the notching operation, the electric cylinder 601 presses down, and the spiral cutting roller squeezes the strip material, and is therefore forced by the advancing strip and driven to rotate along the strip surface, leaving on the strip surface notches at an angle with the direction of strip width. This driven configuration of the spiral cutting roller is preferred.

The extension direction of the cutting edge in any position on the spiral cutting roller 620 and the travel direction of the strip may have an angle of 0-90°. The travel direction of the strip is perpendicular to the axis of the spiral cutting roller. When the angle is less than 20°, the driven effect of the spiral cutting roller is poor, slipping may occur, which result in unstable notching. In the case of a large angle, although the notching operation is stable, a greater wear on the cutting roller can be caused. In addition, the large angle between the cutting edge and the travel direction of strip will lead to a large angle between the notch on the surface of the strip and the width direction of the strip, which is not conducive to the refinement of the magnetic domains by the notches. Therefore, the angle is preferably in the range of 20-60°, more preferably in the range of 20-45°, and still more preferably is 20°.

The mechanical notches may be continuous or discontinuous dotted or linear notches. Considering the processing efficiency, the notches are preferably in the form of continuous or discontinuous linear notch arrays.

The cutting edges of the transverse cutting roller in FIG. 3 and the spiral cutting roller in FIGS. 4a and 4b are all continuous, and can thus form continuous linear notches on the strip surface. However, the cutting edge can also be discontinuous, so as to form discontinuous linear notches.

The cutting roller may also consist of multiple cutting roller parts that can be disassembled and assembled individually. In this case, it is possible to disassemble only the worn or damaged part of the cutting roller and repair it or replace it without having to replace the entire cutting roller.

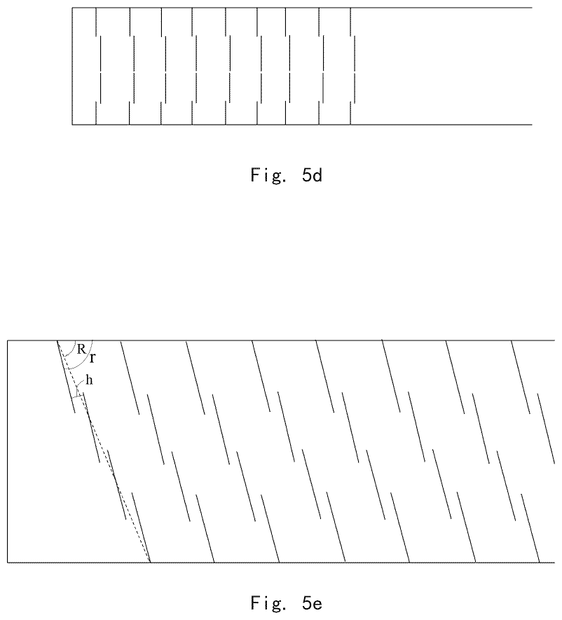

FIGS. 5a-5e show some examples of notch arrangement patterns that can be effected on the strip by the transverse cutting roller 610 and the spiral cutting roller 620. According to the requirements for the arrangement pattern of the notches on the strip, a plurality of cutting edges spaced apart in the axial direction or circumferential direction may be provided on the transverse cutting roller 610, and a plurality of transverse cutting rollers with cutting edges may also be mounted fixedly and side-by-side on the traveling element of the linear motor 602, wherein the cutting edges of the plurality transverse cutting rollers may be aligned or staggered with each other as desired. The spiral cutting roller 620 may also be provided with a plurality of cutting edges (as shown in FIG. 4b). The axial length of the spiral cutting roller can be set as required. Usually, the axial length of the cutting roller is greater than the width of the strip.

FIGS. 5a-5d illustrate notch arrangements in which the notches extend in a direction perpendicular to the travel direction of the strip.

In FIGS. 5a-5b, the spacing between adjacent notches is preferably 1-30 mm, more preferably 2 mm, still more preferably 3 mm, and yet still more preferably 5 mm. The length of the notches in the width direction of the thin amorphous alloy strip is not less than 70%, and preferably 100% of the width of the strip. In the discontinuous linear notch arrangement as shown in FIG. 5b, a discontinuous linear notch array is formed by linear notch segments. Assuming that the width of the thin amorphous alloy strip is D, the length of any one of the notch segments in the discontinuous linear notch array is approximately d, and the number of the notches is m (m≥1), then D≥dm. For these discontinuous linear notches, the notch segments may be inconsistent, it is because factors such as inconsistent notching pressure in various points or cutter wear during the mechanical notching operation will cause difference in the length of the notch segments, e.g., some notch segments have not completely scratched the surface of the thin amorphous alloy strip.

Discontinuous notches may also be arranged in a staggered manner, as shown in FIG. 5c. In a notch array formed by one or more notch segments extending in the width direction of the thin amorphous alloy strip, the distance h between adjacent notch segments in the strip casting direction should not be too large, otherwise it will not be able to refine the magnetic domains. Assuming that the spacing between adjacent notch columns is H, and each notch column comprises m notch segments, then the distance between the adjacent notch segments in each notch column in the strip casting direction should meet h≤H/2(m−1), whereby it can be ensured that the spacing between adjacent notch segments in each notch column in the strip casting direction is not too large and the notch segments are arranged uniformly.

On condition that the above equation is meet, each notch segment of the discontinuous linear notches can be arranged arbitrarily. For example, FIG. 5d shows another arrangement.

FIG. 5e illustrates a discontinuous linear notch arrangement where the notches are at an angle with the strip casting direction, which can be effected for example, on the strip by the spiral cutting roller 620. Each notch segment in the discontinuous linear notches can be oblique. The angle r between each notch segment and the strip casting direction is preferably greater than 45°, more preferably not less than 70° and still more preferably not less than 80°. In addition, the angle R between the line connecting the end point of the discontinuous linear notch column on one side of the strip and the end point on the other side and the strip casting direction is greater than 45°, preferably greater than 80°, and further preferably 90°. And, ∠R≤∠r.

The mechanical notching cutting roller according to the present invention is made of high-hardness materials such as high-speed steel, ceramic steel, tungsten carbide steel, etc. The method according to the present invention is suitable for Fe-based amorphous alloy strips of various compositions. The thin amorphous alloy strip may be a thin strip that has not been cut after casting (e.g., strip roll) or a thin strip that has been cut to the desired size after casting. Preferably, the thickness of the thin amorphous alloy strip is 24-30 μm.

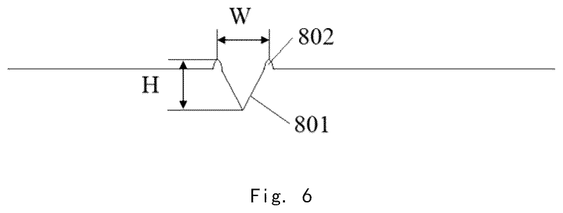

FIG. 6 shows the surface morphology of the amorphous alloy strip after forming notches using the mechanical notching method according to the present invention. In the mechanical notching process of the present invention, the cutting edge of the cutting roller squeezes on the strip surface 800 to form a notched groove 801, which will usually also cause material accumulation on the outer edge of the notched groove 801 and form a bulge 802 as shown in FIG. 6. If there is a large bulge on at least one side of the notched groove, the lamination factor will be seriously affected when the strip is used subsequently to make a transformer core and other devices. The designed magnetic density of the transformer will also be affected. In general, a bulge can be considered as a micro-bulge when it is less than 0.5 μm in height; when the height of the bulge is greater than 0.5 μm, it is regarded as a large bulge, and will have a non-negligible adverse effect on the strip performance.

In order to form effective notches, it should be ensured that the pressure at the position where the cutting edge of the cutting roller is in contact with the strip is 0.1-1.5 MPa/cm². Preferably, the pressure of the cutting edge of the cutting roller at the position where it is in contact with the strip is set in the range of 0.36-0.56 MPa/cm², and preferably 0.4 MPa/cm², so as to better control the height of the bulge and the width and depth of the notch.

TABLE 1
below shows the measurement results of the surface morphology of
the strip around the notch when a tungsten steel made spiral cutting
roller is used, wherein the pressure at the postition where the cutting
edge of the cutting roller is in contact with the strip is in the range
of 0.1-1.5 MPa/cm², the incident angle of the cutting edge is 8°-82°, and
the formed notches has a spacing h of 15 mm and an angle R of 70°
with the strip casting direction.

| | Cutting | | | Notch | |
|---|---|---|---|---|---|
| | edge | Cutting | Notch | upper | |
| | incident | edge | depth | end | |
| Experiment | angle | pressure | H | width W | |
| No. | (°) | (MPa/cm²) | (μm) | (μm) | Bulge size |
| 1 | 8 | 0.15 | 1.21 | 19.407 | Large bulge |
| 2 | 8 | 0.22 | 2.19 | 23.581 | Large bulge |
| 3 | 8 | 0.28 | 2.243 | 24.242 | Large bulge |
| 4 | 8 | 0.36 | 2.441 | 21.281 | Large bulge |
| 5 | 8 | 0.43 | 2.313 | 25.522 | Large bulge |
| 6 | 8 | 0.70 | 2.307 | 23.091 | Large bulge |
| 7 | 8 | 1.05 | 2.106 | 23.965 | Large bulge |
| 8 | 20 | 0.15 | 2.21 | 20.635 | Large bulge |
| 9 | 20 | 0.22 | 2.401 | 26.951 | Large bulge |
| 10 | 20 | 0.28 | 2.627 | 26.98 | Large bulge |
| 11 | 20 | 0.36 | 2.572 | 27.376 | Micro-bulge |
| 12 | 20 | 0.43 | 2.955 | 27.726 | Micro-bulge |
| 13 | 20 | 0.49 | 3.455 | 29.766 | Micro-bulge |
| 14 | 20 | 0.56 | 3.645 | 31.492 | Micro-bulge |
| 15 | 20 | 0.70 | 3.922 | 33.211 | Large bulge |
| 16 | 20 | 1.05 | 4.184 | 38.323 | Large bulge |
| 17 | 25 | 0.15 | 2.321 | 21.035 | Large bulge |
| 18 | 25 | 0.22 | 2.601 | 21.551 | Large bulge |
| 19 | 25 | 0.28 | 2.875 | 22.918 | Large bulge |
| 20 | 25 | 0.36 | 2.913 | 27.457 | Micro-bulge |
| 21 | 25 | 0.43 | 3.454 | 29.832 | Micro-bulge |
| 22 | 25 | 0.49 | 3.567 | 30.911 | Micro-bulge |
| 23 | 25 | 0.56 | 3.822 | 32.124 | Micro-bulge |
| 24 | 25 | 0.70 | 4.012 | 34.136 | Large bulge |
| 25 | 25 | 1.05 | 4.247 | 39.923 | Large bulge |
| 26 | 30 | 0.15 | 2.601 | 20.989 | Large bulge |
| 27 | 30 | 0.22 | 2.869 | 21.937 | Large bulge |
| 28 | 30 | 0.28 | 3.086 | 23.352 | Large bulge |
| 29 | 30 | 0.36 | 3.392 | 27.168 | Micro-bulge |
| 30 | 30 | 0.43 | 3.989 | 27.520 | Micro-bulge |
| 31 | 30 | 0.49 | 4.029 | 31.292 | Micro-bulge |
| 32 | 30 | 0.56 | 4.183 | 32.998 | Micro-bulge |
| 33 | 30 | 0.70 | 4.217 | 34.903 | Large bulge |
| 34 | 30 | 1.05 | 4.358 | 40.992 | Large bulge |
| 35 | 48 | 0.15 | 1.675 | 12.204 | Large bulge |
| 36 | 48 | 0.22 | 2.265 | 13.898 | Large bulge |
| 37 | 48 | 0.28 | 2.283 | 15.399 | Large bulge |
| 38 | 48 | 0.36 | 2.334 | 14.767 | Large bulge |
| 39 | 48 | 0.43 | 2.74 | 13.456 | Large bulge |
| 40 | 48 | 0.49 | 3.253 | 18.748 | Large bulge |
| 41 | 48 | 0.56 | 3.591 | 21.233 | Large bulge |
| 42 | 65 | 0.15 | 1.98 | 11.721 | Large bulge |
| 43 | 65 | 0.22 | 1.967 | 12.56 | Large bulge |
| 44 | 65 | 0.28 | 1.826 | 13.077 | Large bulge |
| 45 | 65 | 0.36 | 1.467 | 12.439 | Large bulge |
| 46 | 65 | 0.43 | 1.337 | 14.042 | Large bulge |
| 47 | 65 | 0.70 | 1.135 | 23.464 | Large bulge |
| 48 | 65 | 1.05 | 3.296 | 26.091 | Large bulge |
| 49 | 82 | 0.15 | 1.637 | 14.421 | Large bulge |
| 50 | 82 | 0.22 | 1.738 | 14.758 | Large bulge |
| 51 | 82 | 0.28 | 1.799 | 15.485 | Large bulge |
| 52 | 82 | 0.36 | 1.898 | 16.855 | Large bulge |
| 53 | 82 | 0.43 | 1.713 | 25.522 | Large bulge |
| 54 | 82 | 0.70 | 1.514 | 17.464 | Large bulge |
| 55 | 82 | 1.05 | 2.133 | 16.45 | Large bulge |

As can be seen from above table, when the incident angle of the cutting edge is in the range of 20°-30° and the notching pressure of the cutting edge is in the range of 0.36-0.56 MPa/cm², a micro-bulge on the edge of the notched groove can be achieved and the optimum surface morphology can be obtained.

TABLE 2
below shows the loss value of the notched strip of some of above experiments.

| | | | | Notch | | |
|---|---|---|---|---|---|---|
| | Cutting edge | Cutting edge | Notch | upper end | | |
| Experiment | incident | pressure | depth H | width W | | Loss |
| No. | angle (°) | (MPa/cm²) | (μm) | (μm) | Bulge size | (VA/kg) |
| 4 | 8 | 0.36 | 2.441 | 21.281 | Large bulge | 0.062 |
| 5 | 8 | 0.43 | 3.012 | 28.206 | Large bulge | 0.058 |
| 11 | 20 | 0.36 | 2.572 | 27.376 | Micro-bulge | 0.055 |
| 12 | 20 | 0.43 | 2.955 | 27.726 | Micro-bulge | 0.045 |
| 29 | 30 | 0.36 | 3.392 | 27.168 | Micro-bulge | 0.052 |
| 30 | 30 | 0.43 | 3.989 | 27.520 | Micro-bulge | 0.046 |
| 38 | 48 | 0.36 | 2.334 | 14.767 | Large bulge | 0.054 |
| 39 | 48 | 0.43 | 2.74 | 13.456 | Large bulge | 0.058 |
| 45 | 65 | 0.36 | 1.467 | 12.439 | Large bulge | 0.067 |
| 46 | 65 | 0.43 | 1.337 | 14.042 | Large bulge | 0.068 |
| 52 | 82 | 0.36 | 1.898 | 16.855 | Large bulge | 0.064 |
| 53 | 82 | 0.43 | 1.713 | 25.522 | Large bulge | 0.060 |

It can be seen from the table above that a notched strip with a micro-bulge has a lower loss than a notched strip with a large bulge.

In the case that a transverse cutting roller is used, the pressures on both sides of the cutting edge are approximately the same during the notching, so it is easier to control the bulge, but it is still required to select appropriate parameters to prevent the bulge from being too high. The present invention proposes that by controlling the pressure and setting the pressure at the cutting edge in the range of 0.1-1.5 MPa/cm², preferably 0.4 MPa/cm², bulges with a height of no more than 0.5 μm, or even no bulge, can be achieved on both sides of the notched notch.

The table below lists the comparison between parameters of the mechanically notched amorphous alloy strip manufactured with the method of the present invention and the laser-notched amorphous alloy strip.

The table below shows a comparison of some parameters of the mechanically notched strip with a micro-bulge obtained by using the mechanical notching method of the present invention and the laser-notched strip obtained by using the conventional laser notching method. The same FeSiBC series amorphous alloy strip is used as the base material, wherein the mechanically notched strips in the embodiments have the same notch arrangement as the laser-notched strips in the comparison examples, namely the notch spacing is 15 mm; the notch depth is in the range of 3-4.5 μm, preferably 3.5 μm; and the notch width is in the range of 27-33 μm, preferably 28 μm. In these ranges, differences in the depth and width of the notch would not affect the performance of the notched strip. Therefore, notches of the above specifications are preferred for both the mechanically notched strip and the laser-notched strip used in the experiments.

| | | | Iron loss |
|---|---|---|---|
| | Specifications | Lamination factor | (50 hz, 1.3 T) |
| Embodiment | Mechanically notched | 0.86 | 0.0571 |
| 1 | strip | | |
| | The notch is a | | |
| | continuous straight | | |
| | line perpendicular to | | |
| | the strip casting | | |
| | direction. | | |
| Embodiment | Mechanically notched | 0.86 | 0.0565 |
| 2 | strip | | |
| | The notch is a | | |
| | continuous straight | | |
| | line perpendicular to | | |
| | the strip casting | | |
| | direction. | | |
| Embodiment | Mechanically notched | 0.86 | 0.0566 |
| 3 | strip | | |
| | The notch is a | | |
| | continuous straight | | |
| | line at 80° with the | | |
| | strip casting direction. | | |
| Embodiment | Mechanically notched | 0.86 | 0.0574 |
| 4 | strip | | |
| | The notch is a | | |
| | continuous straight | | |
| | line at 80° with the | | |
| | strip casting direction. | | |
| Comparison | Original strip | 0.88 | 0.1124 |
| example 1 | (with no notches) | | |
| Comparison | Laser-notched strip | 0.85 | 0.0569 |
| example 2 | The notch is a | | |
| | continuous straight | | |
| | line perpendicular to | | |
| | the strip casting | | |
| | direction. | | |

As can be seen from above table, the mechanically notched strip according to the present invention has a better lamination factor than that of the laser-notched strip with the same notch arrangement, and has an iron loss substantially the same as that of the laser-notched strip.

Finally, it should be noted that the above embodiments are only used to illustrate the technical solutions of the present invention, but do not intend to limit them. Although the present invention is described in detail with reference to the foregoing embodiments, a person skilled in the art should understand that modification can be carried out on the technical solutions recited in the foregoing embodiments, or some of the technical features therein can be replaced with equivalent features. However, these modifications or replacements do not make the essence of the technical solutions depart from the spirit and scope of the technical solutions of the embodiments of the present invention.

1. A method of manufacturing a thin amorphous alloy strip with notches,
characterized in that the method comprises forming notches on a smooth amorphous alloy strip using a cutting roller in a notching operation;
wherein the cutting roller has a cylindrical body, the body is provided on the surface with at least one spirally extending cutting edge, and during the notching operation, the cutting roller is pressed against the amorphous alloy strip and rotated,
wherein an incident angle of the cutting edge is in the range of 20°-30°, a notching pressure of the cutting edge is in the range of 0.1-1.5 MPa/cm²; and an extension direction of any point on the cutting edge has an angle in the range of 20-60° with the travel direction of the amorphous alloy strip.

2. The method according to claim 1, wherein during the notching operation, the cutting roller is driven by a motor to move in a travel direction parallel to the travel direction of the amorphous alloy strip.

3. The method according to claim 1, wherein during the notching operation, the amorphous alloy strip drives the cutting roller to rotate.

4. The method according to claim 1, wherein the extension direction of any point on the cutting edge has an angle in the range of 20-45° with the travel direction of the amorphous alloy strip.

5. The method according to claim 1, wherein the extension direction of any point on the cutting edge has an angle of 20° with the travel direction of the amorphous alloy strip.

6. The method according to claim 1, wherein during the notching operation, the pressure at the cutting edge is in the range of 0.36-0.56 MPa/cm².

7. The method of claim 6, wherein during the notching operation, the pressure at the cutting edge is 0.4 MPa/cm².

8. A method of manufacturing a thin amorphous alloy strip with notches, characterized in that the method comprises forming notches on a smooth amorphous alloy strip using a cutting roller in a notching operation;
wherein the cutting roller has a cylindrical body; the body is provided on the surface with at least one transversely extending cutting edge; and during the notching operation, the cutting roller is pressed against the amorphous alloy strip and rotates around a central axis while moving in a travel direction perpendicular to a travel direction of the strip,
wherein during the notching operation, a pressure at the cutting edge is in the range of 0.1-1.5 MPa/cm².

9. The method according to claim 8, wherein during the notching operation, the pressure at the cutting edge is in the range of 0.36-0.56 MPa/cm².

10. The method according to claim 9, wherein during the notching operation, the pressure at the cutting edge is 0.4 MPa/cm².

11. A thin amorphous alloy strip, wherein the thin amorphous alloy strip has one or more continuous or discontinuous linear notches formed on its surface using a cutting roller, wherein bulges on both sides of the notch are not higher than 0.5 μm, wherein during the notching operation, the cutting roller is pressed against the amorphous alloy strip and rotates around a central axis while moving in a travel direction perpendicular to a travel direction of the stip.

12. (canceled)

13. The thin amorphous alloy strip according to claim 11, wherein an extension direction of the notch is perpendicular to a casting direction of the thin amorphous alloy strip.

14. The thin amorphous alloy strip according to claim 13, wherein a distance between adjacent notches is 1-30 mm.

15. The thin amorphous alloy strip according to claim 13, wherein an extension length of the notch is greater than or equal to 70% of the width of the thin amorphous alloy strip.

16. The thin amorphous alloy strip according to claim 13, wherein, for a discontinuous linear notch array formed by linear notch segments, assuming that a width of the thin amorphous alloy strip is D, a length of any notch segment in the discontinuous linear notch array is d, and the number of the notch is m (m>1), then D≥dm.

17. The thin amorphous alloy strip according to claim 11, wherein for a discontinuous linear notch array formed by linear notch segments, assuming that a spacing between adjacent notch columns is H, and each notch column comprises m notch segments, then a distance between adjacent notch segments in each notch column in the strip casting direction meets h≤H/2(m−1).

18. The thin amorphous alloy strip according to claim 11, wherein a discontinuous linear notch array is formed by linear notch segments, and an angle ∠r between each notch segment and the strip casting direction is greater than 45°.

19. The thin amorphous alloy strip according to claim 18, wherein an angle ∠R between a line connecting an end point of the discontinuous linear notch column on one side of the strip and an end point on the other side and the strip casting direction is greater than 45°, and ∠R≤∠r.

20. A manufacturing device for forming notches on an amorphous alloy strip, the device comprising:
a discharging unit, which unwinds a strip roll;
a tension adjusting mechanism, which adjusts a tension of the strip;
a process deviation rectifying mechanism, which ensures that the strip does not deviate in operation; and
a notching mechanism, which carries out a notching operation on the strip;
wherein the notching mechanism comprises a cutting roller traveling mechanism, a cutting roller and a cutting board, the cutting roller has a cylindrical body and at least one cutting edge protruding from a surface of the body and extending circumferentially or spirally on the surface of the body.

21. The manufacturing device according to claim 20, wherein the manufacturing device further comprises:
a length metering mechanism, which measures the length that the strip has travelled;
a tension detecting mechanism, which detects a tension of the strip; and
a receiving mechanism which winds up the amorphous alloy strip that has been notched.

22. The manufacturing device according to claim 20, wherein an extension direction of any point on the cutting edge has an angle in the range of 30-70° with the axis of the cutting roller.
